(19) United States
(12) Patent Application Publication
(10) Pub. No.: US 2016/0371447 A1
(43) Pub. Date: Dec. 22, 2016

(54) MEDICAL DIAGNOSIS AND PROCEDURE CODER METHOD

(71) Applicant: DATA TRACE PUBLISHING COMPANY, Towson, MD (US)

(72) Inventor: L. Andrew Koman, Winston-Salem, NC (US)

(73) Assignee: DATA TRACE PUBLISHING COMPANY, Towson, MD (US)

(21) Appl. No.: 15/188,509

(22) Filed: Jun. 21, 2016

Related U.S. Application Data
(60) Provisional application No. 62/231,000, filed on Jun. 22, 2015.

(51) Int. Cl. G06F 19/00

(52) U.S. Cl. CPC G06F 19/345; G06F 19/328; G06F 19/325; G06Q 2220/00

(57) ABSTRACT

A billing method for diagnostic coding, documentation and billing for specialized medical practice in which the method comprises capturing a treatment event by accessing a host computer with a billing program having a plurality of prompt menu screens with data terms directed to a specialized medical practice with a remote device. The method has the steps of:
(a) connecting a remote device to a host computer via the internet;
(b) entering specific treatment event data terms selected from data terms shown on a prompt menu screens which correspond to a patient diagnosis to a host computer;
(c) matching a selected treatment event data terms selected from a prompt menu screens to a specific billing code maintained in a database connected to a host computer;
(d) generating information for computerized charge entry or creating an invoice for all of the collected selected data terms entered with predetermined standard code identifiers for a specific patient from a host computer; and
(e) transmitting a completed invoice to a remote device.

### RELATED APPLICATIONS

This is a utility patent application claiming priority and benefit from U.S. Provisional Patent Application No. 62/231,000, filed Jun. 22, 2015.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None.

### BACKGROUND OF THE INVENTION

1. Field of the Invention

The present invention relates to diagnostic coding and billing methods and systems, and, more particularly to coding and billing methods and systems for creating and capturing diagnostic codes required for documentation of care for capturing and billing medical services in an ICD-9 and ICD-10 coded format.

In the United States today, health care costs are skyrocketing and the information necessary within mandated electronic medical records in order to fulfill government and private insurance carrier requirements, “meaningful use” and appropriate documentation is increasing.

The days of a single family practice doctor or nurse looking up and typing diagnosis codes (ICD-10) for documentation and medical bills for services rendered are gone. Even small offices and clinics have changed and they must enter diagnostic and procedure codes in order to complete computer billing. Diagnoses are based upon the history, examination and ancillary tests and consist of the description (e.g. cerebral palsy) and the ICD-9 or ICD-10 code (e.g. 343.9 or G80.9, respectively). Procedure codes similarly include a description of what was done and a numeric CPT code. The descriptor in ICD-9 is either supplied at point of service or by coders. The complexity of ICD-10 is such that the descriptor must be very detailed in order to correctly file documentation or submit a bill. In large clinics and hospitals, the billing departments are virtually (if not entirely) separate from the actual process of doctors and nurses providing medical care. The people working in billing departments may have limited medical backgrounds and are mainly concerned with generating bills for medical services and collecting money for the same. Often the billing department personnel cannot provide a proper explanation for the charges since the procedure codes used in the bills are created by others (e.g. the medical records department or medical staff where the services are rendered) and the charges for the services and items provided are generated from multiple sources (check-off sheets, swiped bar codes on supplies, pharmacy dispensing records, automated rules, etc.).

Generally, medical bills are not designed for a patient to understand and there is no system set up to make it convenient for a patient to ask questions, get information or even have someone adjust errors in a medical bill. In order to bill for a procedure (CPT), a diagnosis (ICD-9 or 10) are required.

Insurance companies and other group health payers have adopted a multi-faceted strategy known as managed care. In addition to controlling the prices they pay, under managed care, insurance companies use other “managed care” methods including sets of rules that specify, for a given, disease or injury, the type of treatments and the quantity of such treatments that the payor will pay. Therefore diagnostic codes are critical both for optimal patient care and billing.

The Centers for Medicare and Medicaid Services (CMS) is the Federal agency responsible for the operation and oversight of federally-funded Medicare and Medicaid medical insurance programs. These medical insurance programs handle the medical claims submitted by health care providers, such as doctors, hospitals. The medical insurance programs then reimburse claims that are valid and correctly coded. Medicare has implemented various rules and controls that place an enormous burden upon health care providers to code and bill in accordance with Medicare's stringent and ever-changing rules.

2. Description of the Prior Art

Medical facilities use medical billing systems to collect and process information needed to prepare claims relating to medical care provided to patients. These claims are submitted to payers such as insurance companies, Medicare, and patients. Many medical facilities, especially outpatient clinics in hospitals, use “split billing” charge practices. Split billing refers to the practice of providing technical charges to a payer separately from professional charges for each patient encounter at the medical facility. Professional charges refer to charges for services rendered by physicians and other professional medical providers for each patient encounter. Technical charges refer to charges for use of facilities, clinical staff time, procedures performed by clinical staff, medications, and supplies used in the course of care for a patient.

The technical charges for a patient encounter are usually closely related to the professional charges. Typically, many professional charges have a corresponding technical component. For example, procedures performed by a physician at the medical facility typically involve technical charges for use of facilities, staff time, and medications and other supplies used in the procedure. Even in an evaluation and management (E/M) visit, activities such as use of an examination room, chart preparation, and patient education are typically billed as technical charges.

Billing codes are used in medical billing records to represent details of medical charges. The billing codes used in medical professional billing records are generally standardized in the industry. Commonly used medical professional billing code lists include CPT-4 codes (Current Procedural Terminology, Version 4—maintained by the American Medical Association). These codes must be accompanied by diagnoses and corresponding codes, HCPCS (Healthcare Common Procedure Coding System) codes, ICD-9-CM (International Classification of Diseases, Ninth Revision, Clinical Modification) and ICD-10-CM (International Classification of Diseases, Tenth Revision, Clinical Modification) codes.

There are two manual codes used by medical billers and insurers: the Current Procedural Terminology (CPT) and International Classification of Diseases (ICD).

The CPT book has codes for reporting medical procedures and services such as diagnostic, laboratory, radiology, and surgical. It describes what was done to the patient during the consultation and the procedure code can be found in the CPT book. It describes the medical services and procedures done by the physician and aims at providing a uniform language to describe the treatment and diagnostic procedures performed and aid in the communication between doctors, patients, and insurance companies.

The ICD book has codes that identify a diagnosis and describe a disease or medical condition. After diagnosing what is wrong with a patient, a physician will assign a diagnosis code which can be found in the ICD-9 or ICD-10 book. It describes the medical condition or disease that is being treated so that all parties involved; the doctor, patient, and insurer will understand better the disease which is being treated.

The CPT book is published by the American Medical Association and has 7,800 codes. The ICD book is published by the World Health Organization and has 24,000 codes for its ICD-9 diagnosis identifiers and more than 125,000 codes for its ICD-10 diagnosis identifiers. The CPT book has a health care common procedure coding system and focuses on medications and equipment for which a patient is billed. This system is not found in the ICD book.

Prior to ICD-10, CPT codes were more complex than ICD codes. While for a certain ailment a diagnosis may only have one code, to determine the code in the CPT coding would involve determining the circumstances of the patient's visit to the physician, the time the doctor spent with the patient, and how many body systems the physician examined among other concerns. In ICD-10 diagnostic coding is significantly more complex with many musculoskeletal conditions requiring 7 characters which indicate the disease or injury, the laterality, the mechanism and the stage of healing.

These codes are an insurance industry standard by which to bill and process medical claims by payers. Claims payment systems, relying on negotiations with providers for managed care solutions, depend on these coding systems to match charges with treatments, translate costs into statistics to identify costs, underwrite health insurance policies, and track patient outcomes and patient utilization.

Medical documentation and bills must be encoded using billing codes specified by technical billing code standards such as ICD-9, ICD-10, and CPT. ICD-10-CM is akin to an upgrade to ICD-9-CM. As previously noted, there are thousands of ICD-9 codes to cover most of the known conditions. Since health care is expanding on a daily basis and health care practitioners are diagnosing numerous conditions, there is a lack of ICD-9 codes. The ICD-10 codes are an expansion of ICD-9 codes. ICD-10 codes differ in that they include a mixture of alphabetic characters, where ICD-9 is numerical. ICD-9 codes and ICD-10 codes include procedure codes and are a mixture of both diagnosis and procedure codes. Such standards can be difficult to understand and apply in particular situations in light of the services provided and the available evidence. Furthermore, as older standards (such as ICD-9) are replaced with newer, more complex, standards (such as ICD-10), the difficulty of understanding the applicable standards are increasing. ICD-9 and ICD-10 are international classifications for diseases, 9^{th} and 10^{th} editions. When one goes to a medical facility (hospital, clinic or doctors office), the physician basically treats the patient for his or her condition and diagnoses the patient with the medical condition. The correct diagnosis and appropriately detailed descriptor is crucial for optimal care and is necessary to correctly assign the mandated ICD-10 code. It is the provider's responsibility to make the diagnosis and document the level of care CPT code for evaluation and management services and any additional CPT codes for procedures performed. The coding may be done by the provider or coder based upon the description of the diagnoses and evaluation or procedures. In ICD-9, the probability of a coder retrospectively providing the correct code is very good; however, in ICD-10, the probability of providing sufficiently detailed descriptors for a third party to assign appropriately specific codes in an efficient, reproducible and cost effective is problematic.

Once the patient leaves the medical facility, a bill must be sent to the insurance company or the Federal government to get paid. In order to be paid, the bill must include an accurate ICD-9 code or an ICD-10 code depending on the specific condition of the patient.

The system and method according to the present invention has been developed to overcome existing coding, billing and documentation issues/problems, thus providing the benefit of generating at point of service both a detailed diagnosis descriptor suitable for ICD-10 and ICD-9 allowing these code(s) to be automatically linked to evaluation and management or procedural CPT codes and to the electronic medical record.

Among traditional healthcare billing systems, several methods and systems are known in the prior art. For example, U.S. Pat. No. 4,491,725, issued Jan. 1, 1985 describes a medical claim verification and processing system in which a medicard is used to access a central brokerage computer for patient information for implementation of a method to rapidly determine an insurance claim payment for a specified patient service. The computer stores a code conversion table for each possible paying insurance carrier for converting patient treatment codes into service codes associated with a claim payment. The end result is an increase in the speed of processing of information, which enables the provider and patient to rapidly assess the current status of the payment of a claim by an insurance carrier.

Systems have been developed to try to automate the function of selecting the proper CPT code. For example, and as described in U.S. Pat. No. 5,325,293, issued Jun. 28, 1994, a system is used to correlate medical procedures and medical billing codes for interventional radiology procedures which includes generating raw codes which correspond with selected medical procedures and then analyzing the raw codes to generate a set of intermediate codes, which account for the interrelation of the selected medical procedures, without altering the raw codes. The billing codes are then generated from the intermediate codes.

Before determining appropriateness of a treatment for a procedure, even when the procedure has been properly classified under a CPT code, the procedure must be appropriate to the diagnosis before payment is made by a payer. Another billing system is discussed in U.S. Pat. No. 4,667,292, issued May 19, 1987 in which a computer system is provided for identifying the most appropriate billing categories, namely Diagnosis Related Groups (DRGs), as also set forth by the Federal government for Medicare reimbursement. The Medicare payment system requires first encoding diagnostic (ICD-9/10-CMs) and procedural (CPT) information, which steps are dependent upon several factors, including a principal diagnosis of the patient's problem, the procedures performed upon the patient, the age of the patient, and the presence or absence of any complications or co-morbidity. DRGs are determined in part by the ICD-9/10-CM coding system, which refers to a coding system based on a compatible with an accepted, original system of classification system of diseases, injuries, impairments, symptoms, medical procedures and causes of death. The ICD-9-CMs are initially divided into Disease and Procedure sections. These sections are further subdivided into subsections which encompass anywhere from 1-999 three digit disease or 1-99 two digit procedure code categories. Within the three digit code categories, there can be an additional 2 digits to divide the codes into subcategories which further define either or both the disease manifestations and diagnostic procedures. ICD-10-CM codes have been added and are currently being added into the billing mix to supplement, change or modify the ICD-9-CM codes.

It has been demonstrated many times that remote stand-alone billing services do not have the resources to create an encompassing set of prompt and accurate billing information. Therefore, it is essential that a complete set of prompt and accurate information for every medical specialty be pre-loaded in a system that could then be easily modifiable within the system to fit prevailing norms. This is especially true for new procedures and cross-over procedures. Most medical related lawsuits require that information about the standard of care be reviewed within the context of time. That is, the standard of care must be that standard that was in force when the incident occurred, not the current standard.

The Federal Government has adopted various payment protocols that today pay almost entirely according to set schedule of fees for the specific services rendered by different types of providers and facilities. The State Governments, when they regulate the appropriate payment for medical services for worker injured and/or auto accident injured victims, also largely use fee schedules. The very large insurance companies, who are providing health insurance largely to employer-sponsored groups, also have adopted fee schedules. These protocols for payments rely on codes currently in force.

The billing codes are very complex and subject to human error during the reporting time period and the medical code diagnosis/treatment mating period. As previously noted, there are several standards that the industry uses but currently the two most favored are CPT and ICD codes. Both systems have a great deal of overlap in their use but ICD codes tend to be used more at the hospital and physician office level while CPT codes are used by outpatient facilities.

There is an entire industry dedicated to analyzing and using these codes for billing purposes however, to date no one has used them in a simple series of prompt screens and menus which correlates to specific billable procedures complete with accurate direct codes. The reason for this is that before a code could be tied to a procedure, a solid set of procedure needs to be established. The associated billing codes also need modification and management to be matched and work effectively in the system.

### SUMMARY OF THE INVENTION

The present invention relates to a method of encoding and processing healthcare diagnosis codes which provide a detailed and accurate diagnosis description using the four (4) numeral ICD-9 code or the 4-7 character ICD-10 code. The diagnosis codes may then be linked to facilitate provider billing, more particularly, a computer assisted network for encoding, documenting and processing claims for a payment of specific procedures performed by medical personnel on patients. Even more specifically, the method employs a host computer accessing a database which runs a series of prompt screens with menus having descriptive medical terms to a remote computer user, nominally a physician, which provide a dial down series of sequential screens requiring input from the physician to identify relevant terms for identifying the diagnosis/procedure performed on a patient. This series of terms mates the diagnosis/procedure with a code associated term, thus coding the diagnosis for the appropriate procedure with the relevant ICD-9-CM or ICD-10-CM code number which is then presented on a host computer generated bill. The bill is sent via email in an encrypted format to the remote computer user and/or the computer of the physician associated with medical facility billing group. As previously noted, it is envisioned that the billing information be encrypted to protect patient confidentiality and comply with HIPPA regulations. There are a number of commercial encryption providers which are well known in the art to provide such encryption services.

In accordance with one or more embodiments of the invention, a computer implemented method is provided for generating an appropriately detailed diagnosis and numerical or character-based code that provides accurate and safe patient care and facilitates processing bills relating to medical care in a specialized medical field, such as podiatry, which is provided to patients at a medical facility. The method includes the steps of: (a) providing to a medical services provider's remote computer from a host computer a sequential series of dial down prompt screens with menus having term listings relating to a specialized medical discipline (e.g., orthopaedics, podiatry, etc.) for selection by a physician, (b) identifying one or more billing codes corresponding to the selected terms queried in step (a) using the mapping terms provided by the prompt screen menus, (c) the prompt screen menu terms generating a mapping of at least one diagnosis and appropriately detailed descriptor with an equivalent ICD-9-CM and/or ICD-10-CM code; (d) transmitting from the host computer to the medical provider remote computer screen a billing record generated from the host computer database listing the medical diagnostic codes pertaining to the patient that may be linked to the appropriate ICD or CPT procedure code; and (e) printing and/or emailing the billing record via the internet to a designated payor of the medical services and/or the medical service provider's billing record storage.

A further feature of the present invention is the provision of a diagnostic billing and records system in which the medical provider provides the information input from a plurality of menu screens generated by a host computer and the host computer links the selected information to a database having associated billing codes.

Another feature of the present invention is the provision that the source of the diagnosis description and codes can be efficiently and precisely generated at the point of service and then seamlessly linked to the proper billing codes also generated at the point of service by the provider with real time knowledge and the most expertise. This places ownership and responsibility for billing and record keeping on the medical service provider.

A further feature of the present invention is the provision of a wireless computer billing and records system.

A still further feature of the present invention is the provision of a billing and records computer system that allows the medical service provider to input data by checking on a set of predetermined terms at the point of service and within an immediate time period after performance of the service.

A yet further feature of the present invention is the provision of a diagnostic, billing and records computer system that allows the medical service provider to input data through a series of menu screens having selected terms, dedicated to a specialized medical area of practice.

Another feature of the present invention is the provision of a billing and records computer system that allows the medical service provider to input data through a series of menu screens having selected terms, dedicated to the specific medical area specialty and all surgical and medical specialties and subspecialties.

The invention will be better understood and objects other than those set forth above will become apparent when consideration is given to the following detailed description thereof. Such description makes reference to the annexed drawings herein.

### BRIEF DESCRIPTION OF THE DRAWINGS

FIG. 1 is a block diagram illustrating a flowchart for processing medical billing records in accordance with one embodiment of the invention;

FIG. 2 shows an entry login screen for the medical service provider for entry into the host computer billing program;

FIG. 3 is an example of an initial menu screen generated by the host computer to the remote computer showing an initial podiatric treatment screen viewed by the medical service provider after login;

FIG. 4 shows a sequential menu screen generated by the host computer based upon selection of data terms by the medical provider on the menu screen shown in FIG. 3;

FIG. 5 shows a sequential menu screen generated by the host computer based upon the selection of data terms by the medical provider on the menu screen shown in FIG. 4;

FIG. 6 shows a sequential menu screen generated by the host computer based upon the selection of further data terms by the medical provider on the menu screen shown in FIG. 5;

FIG. 7 shows a sequential menu screen generated by the host computer based upon the selection of further data terms by the medical provider on the menu screen shown in FIG. 6;

FIG. 8 shows a sequential menu screen generated by the host computer based upon selection of further data terms by the medical provider on the menu screen shown in FIG. 7;

FIG. 9 shows a sequential menu screen generated by the host computer based upon selection of data terms by the medical provider on the menu screen shown in FIG. 8;

FIG. 10 shows a sequential menu screen generated by the host computer based upon selection of data terms by the medical provider on the menu screen shown in FIG. 9;

FIG. 11 shows a sequential menu screen generated by the host computer based upon selection of data terms by the medical provider on the menu screen shown in FIG. 10; and

FIG. 12 shows a sequential screen showing the billing for the data information entered by the medical provider in FIGS. 3-11 listing the terminology and appropriate billing code for same.

### DETAILED DESCRIPTION OF THE INVENTION

While the invention is described in connection with certain preferred embodiments, but it is not intended that the present invention be so limited. On the contrary, it is intended to cover all alternatives, modifications, and equivalent arrangements as may be included within the spirit and scope of the invention as defined by the appended claims.

The present invention relates to a method and system of encoding and processing healthcare provider diagnoses and billing, more particularly, a computer assisted network for encoding, documenting and processing the linked diagnoses and evaluation and management and procedure billing charges for specific procedures provided to a patient of a healthcare provider, which billing charges are further verified within a predetermined scope of medical specialty.

The invention consists of the following major sections: (1) the diagnostic information screens and their menu associated terms generated by a host computer which are accessed by a remote computer by a medical practitioner user; (2) matching the diagnostic information obtained by selection of the menu associated terms entered by the medical practitioner remote user by a host computer with billing codes in a database associated with the host computer; (3) generating billing codes for the selected terms entered by the remote medical practitioner user; and (4) transmitting a coded bill with diagnostic terms back to the remote medical practitioner and/or to a designated medical service payor. It is to be understood that the medical area specialty illustrated is for the purpose of example and is not meant to be limited to that area.

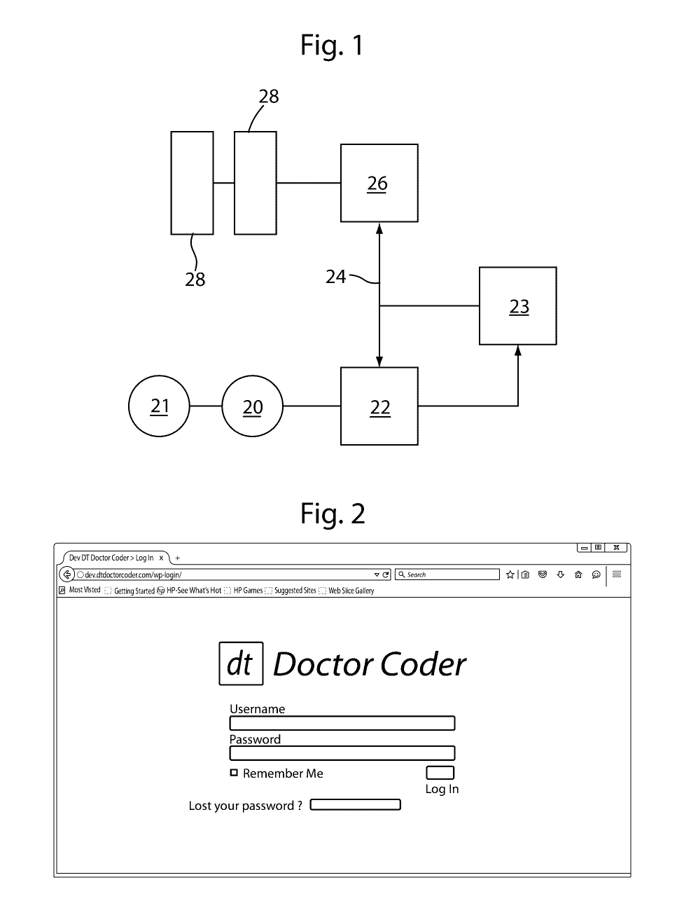

The preferred embodiment of the apparatus and method and best mode is rendered in FIGS. 1 through 12. The elements described herein apply to both the aforementioned preferred embodiments.

The present invention uses an interactive, subscription-based, ICD-10-CM and/or ICD-9-CM coder software billing program designed for physicians, medical practitioners, office personnel, and the bill payers to help them quickly and easily determine specific ICD-9 or ICD-10 codes required for claims and electronic health records, as mandated by the Centers for Medicare & Medicaid Services for anyone covered by the Health Insurance Portability Accountability Act (HIPAA).

The electronic software used with the invention is the first of its kind that takes an intuitive approach to determining ICD-9-CM and ICD-10-CM diagnostic codes. Based on logic typically followed by physicians and medical personnel when diagnosing and performing procedures for a patient's medical condition, the user can quickly and easily navigate through an appropriate sequence of medical menus electing specific content from same to determine the correct ICD-9-CM and ICD-10-CM diagnostic codes. Bills must be encoded using billing codes specified by technical billing code standards such as ICD-9-CM, ICD-10-CM, and CPT. Such standards can be difficult to understand and apply in particular situations in light of the services provided and the available evidence. Furthermore, as older standards (such as ICD-9) are replaced with newer, more complex, standards (such as ICD-10), the difficulty of understanding the applicable standards are increasing. This can be applied to any specialty in medicine such as orthopaedic, neurology, cardiology, oncology, podiatry and the like.

There is no need for extensive training manuals, training programs, or webinars of any kind, for the end-user who is preferably a medical practitioner. The invention has been adapted for use on any electronic platform used by the practitioner to access the host computer, including cell phones, smart watches, smart phones, tablets, notebooks, laptops and computers.

The end-user, preferably a physician, navigates quickly through a series of pop-up and/or sequentially illuminated or activated menus having terms that are relevant to the procedure and physical location of the disease/injury. This is important in ICD-10 since the necessary descriptors to code properly are not consistent from one disease or injury to another. For example, in tibia fracture one must know that the anatomic options are “proximal”, “shaft”, or “distal” and the subsections within each are different. The proper ICD-10 code is then determined by the user's designated answers and can take only seconds to complete.

The following is an example, through screen capture of the intuitive billing program shows how easy it is to navigate using as an example the field of podiatry as an example of the medical specialty.

Before considering some of the important features of this coding method or system of the invention, a brief overview will be provided of the overall method or system. Referring to FIG. 1, the billing process begins with patient intake, a medical practitioner as indicated by block 20, and, as described in more detail below, this involves gathering information about the patient, including, e.g., insurance information.

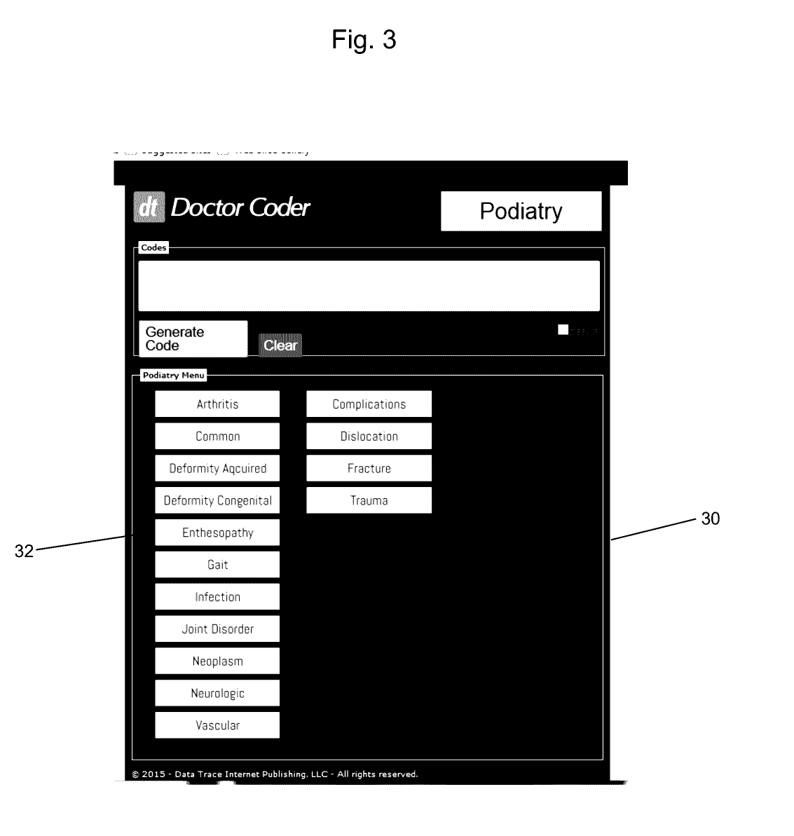

It should be understood, however, that this illustration is merely one example of a specialized medical practices and does not constitute a limitation of the present invention. As seen in FIG. 1, the medical provider, service provider or physician 20, during or after an encounter with (e.g., examination of) a patient 21 connects his or her smart watch, smart phone, tablet, laptop, notebook or computer 22 via the internet 24 and logs onto a restricted website of a host computer 26 using his or her user name and password as is shown in FIG. 2. It should be noted that the terms physician, medical provider, service provider, and user can be used interchangeably depending on the appropriate designation of the person sending out the appropriate medical data to generate the necessary billing code. Upon entry onto the host computer, the physician 20 hits enter on his or her computer 22 and is presented with a first prompt screen menu 30 on his or her laptop 22 with an initial diagnostic menu 32 as is shown in FIG. 3 generated by servers 28 of the offsite host computer 26. It will be appreciated that each diagnostic menu is specifically tailored to a specialized medical discipline such as orthopaedics, podiatry, internal medicine, pulmonary, ear, nose and throat, neurology, cardiology, dermatology and other specialized medical disciplines. The menu shown in FIG. 3 is directed to the medical specialty of podiatry which has relatively simple menus.

As seen in FIG. 3, the physician/service provider/user 20 selects the appropriate injury/condition being diagnosed for patient 21 from terms of diagnostic menu 32. The injury/condition listing selects from the general podiatric diagnostic menu a category of the following terms: Arthritis, Common, Deformity-Acquired, Deformity-Congenital, Enthesopathy, Gait, Infection, Joint Disorder, Neoplasm, Neurologic, Vascular, Complications, Dislocation, Fracture, Trauma. The present example shown in the FIG. 3 is directed to the injury of fracture. After entry of the injury/condition, additional screen menus pop up allowing the user to quickly designate the term listing providing answers for billing. Each of the above noted terms has a sequential set of menu prompt screens which follow the term once it is clicked on and identified. Additional menu terms are provided to each selected term to provide the natural selected intuitive process for the injury/condition listing. It will also be appreciated that each medical specialty will have and use different terms which are related to that medical specialty.

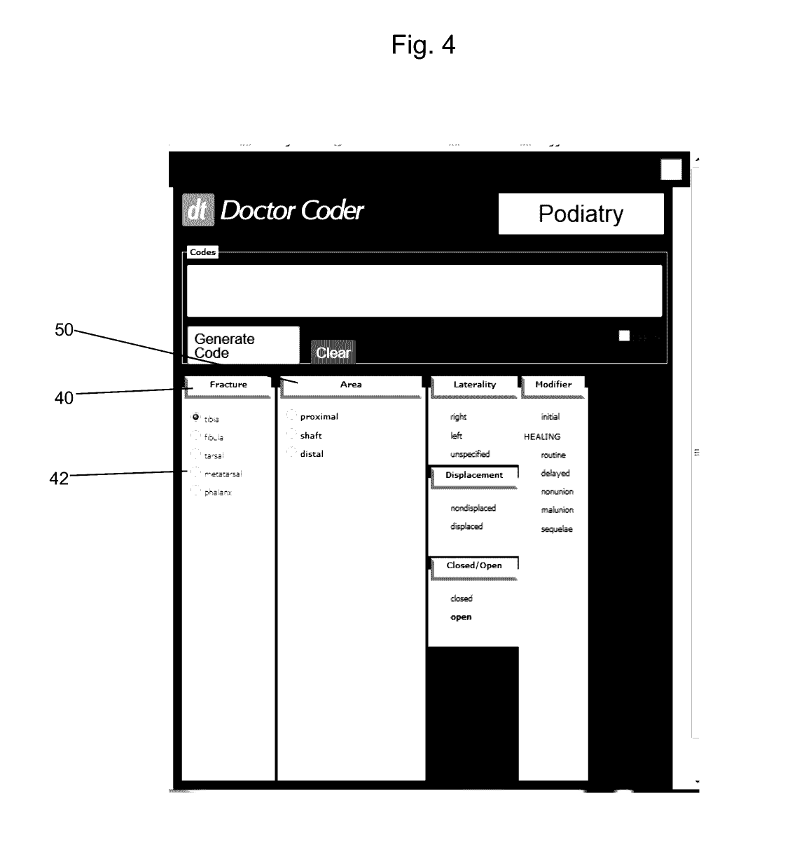

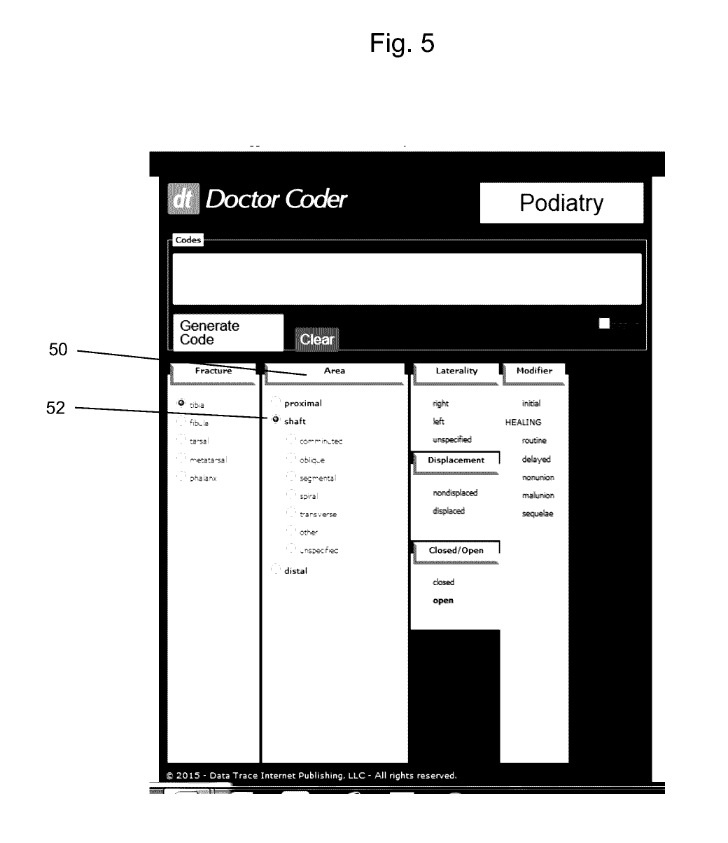

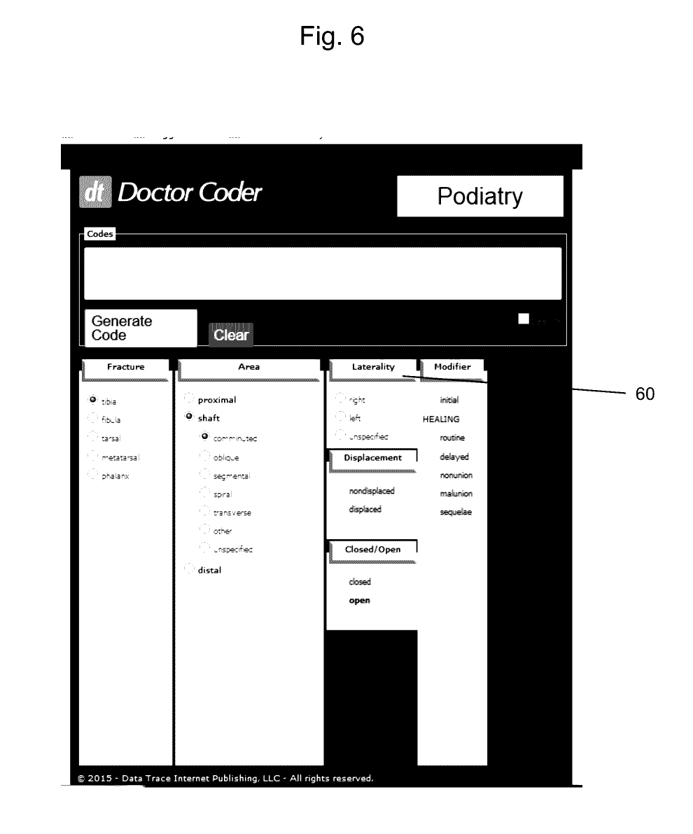

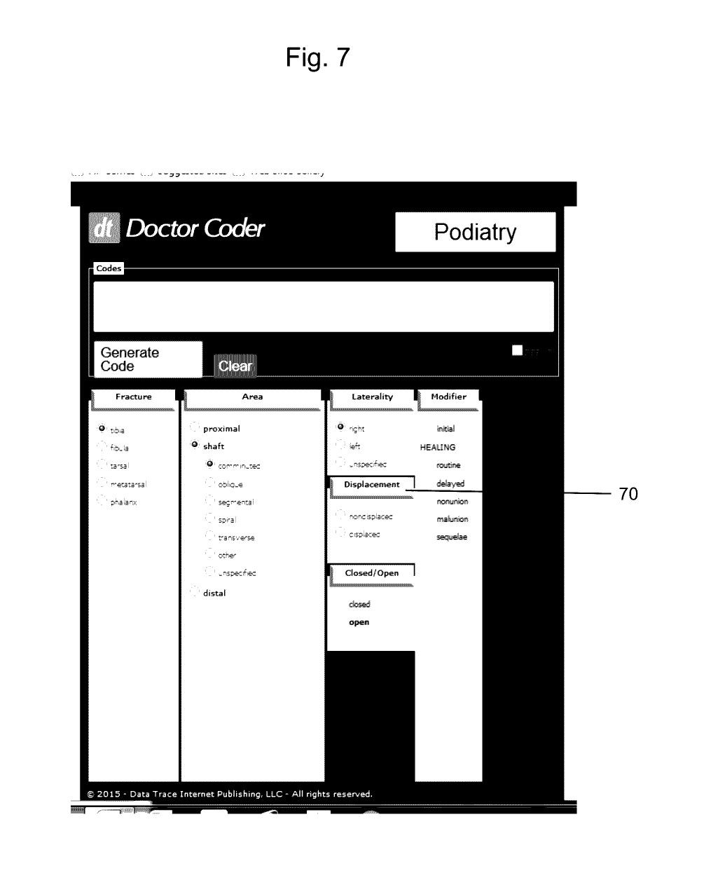

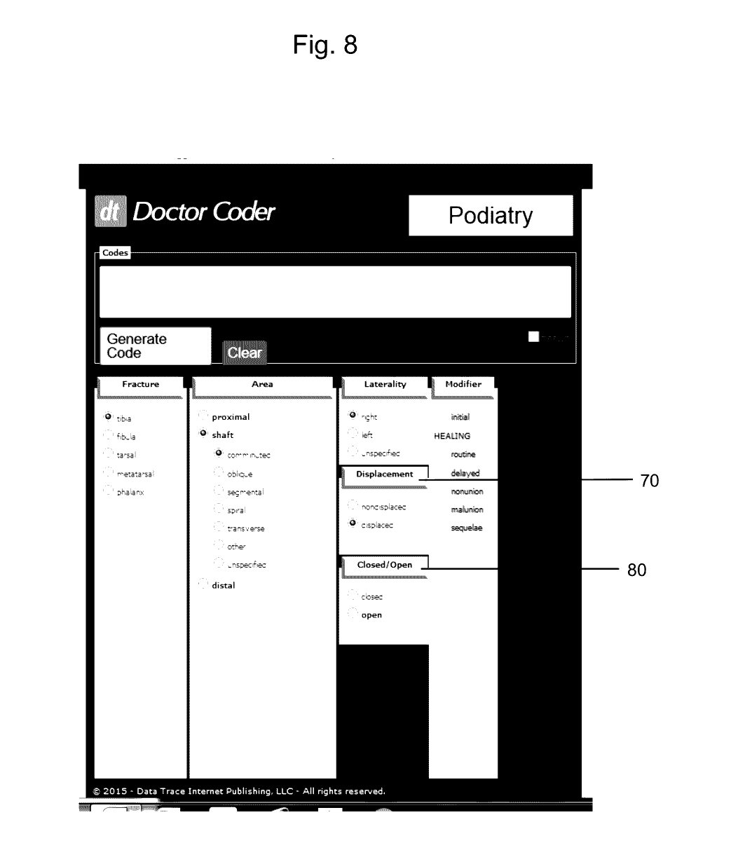

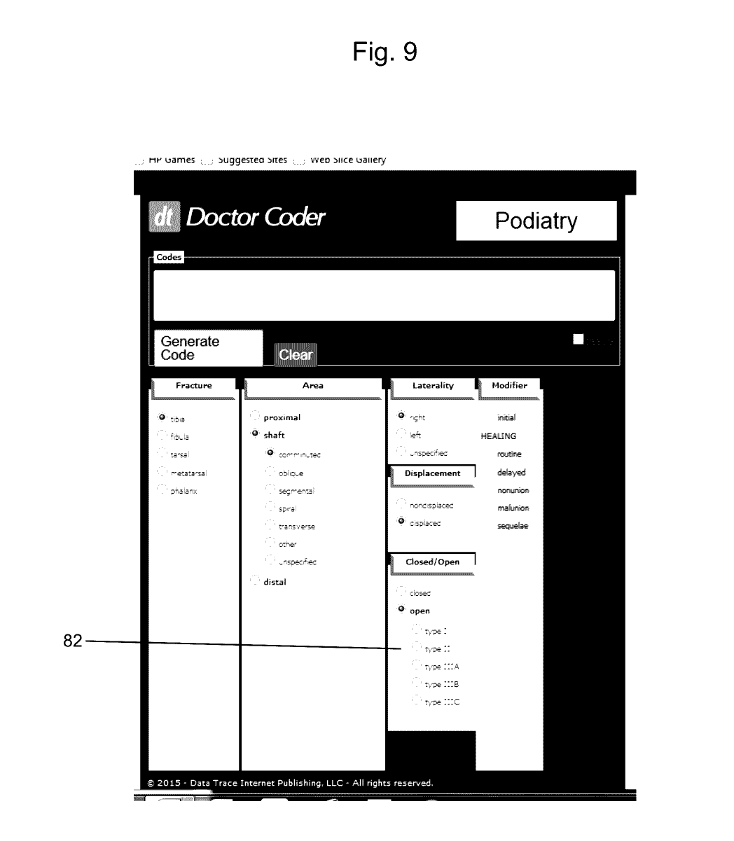

After the initial injury/condition is identified, a sequential screen is generated with the fracture block 40 and area block 50 being illuminated as is seen in FIG. 4. The fracture block menu 40 lists six term selections, namely: tibia, fibula, tarsal, metatarsal and phalanx with a selection circle 42 adjacent each term. In the present example, the bone that is fractured is the tibia and FIG. 4 shows this marking. The next intuitive stage is the area of the fracture and the area block 50 allows the selections of the terms: proximal, shaft and distal. FIG. 5 shows that the shaft has been indicated as the area of the fracture by clicking on the adjacent circle 52 to the term “shaft” and with this selection, an additional listing of the relationship of the fracture to the shaft is shown, namely the terms selections: comminuted, oblique, segmental, spiral, traverse, other, unspecified. In FIG. 6, the option term “comminuted” has been selected by the service provider and the laterality block 60 is highlighted as the next selection to be addressed. The laterality block 60 is provided with the term selections: right, left, and unspecified. In FIG. 7, selection of the term “right” has been chosen in the laterality box 60 and the displacement block 70 is highlighted having the choice of the terms selection: nondisplaced or displaced are shown with an adjacent circle. FIG. 8 shows that the term “displaced” has been chosen by the provider in the displacement block 70 and the closed/open block 80 is highlighted. The service provider then moves to the closed/open block 80 listings and hits the term “open” as is seen in FIG. 9 which changes the menu in the closed/open block 80 to list an additional number of term options 82 under “open”. These options are the terms: Type I, Type II, Type IIIA, Type IIIB, and Type IIIC.

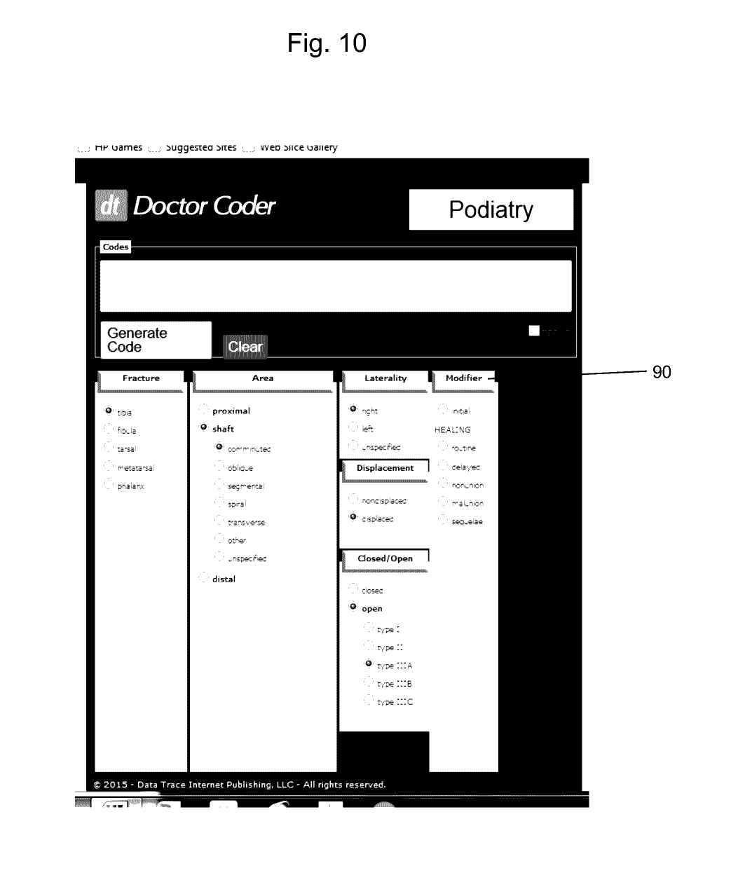

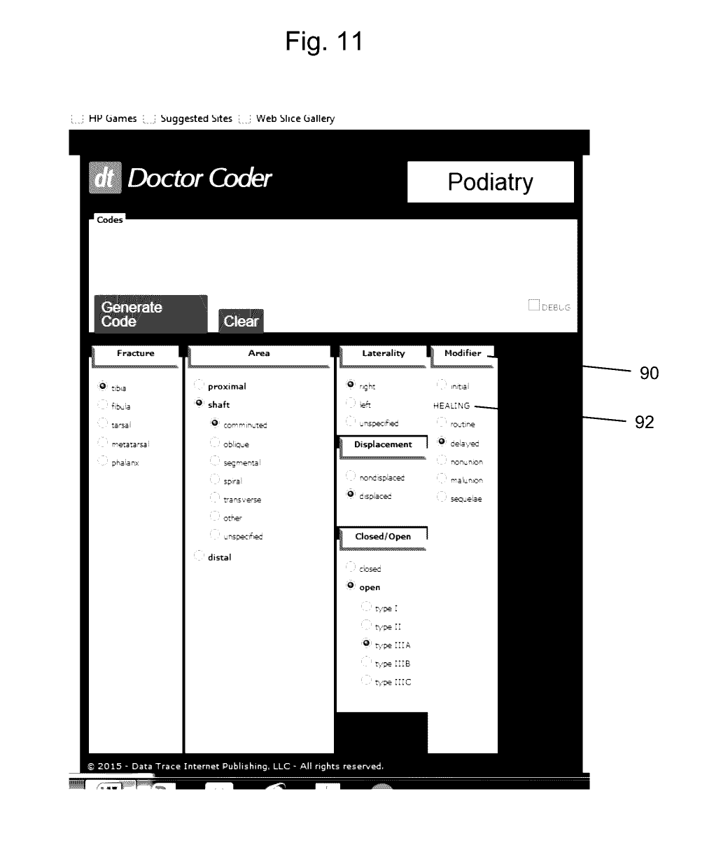

As is shown in FIG. 10, the Gustilo classification Type 111A has been chosen and the modifier block 90 opens and is highlighted. In FIG. 11, a modifier of progress is then selected from the modifier headings block 90 and under subheading “Healing” 92, the terms: routine, delayed, nonunion, malunion, and sequelae are presented. FIG. 11 shows that the selection of the term “delayed” in the modifier block 90 has been selected by the service provider.

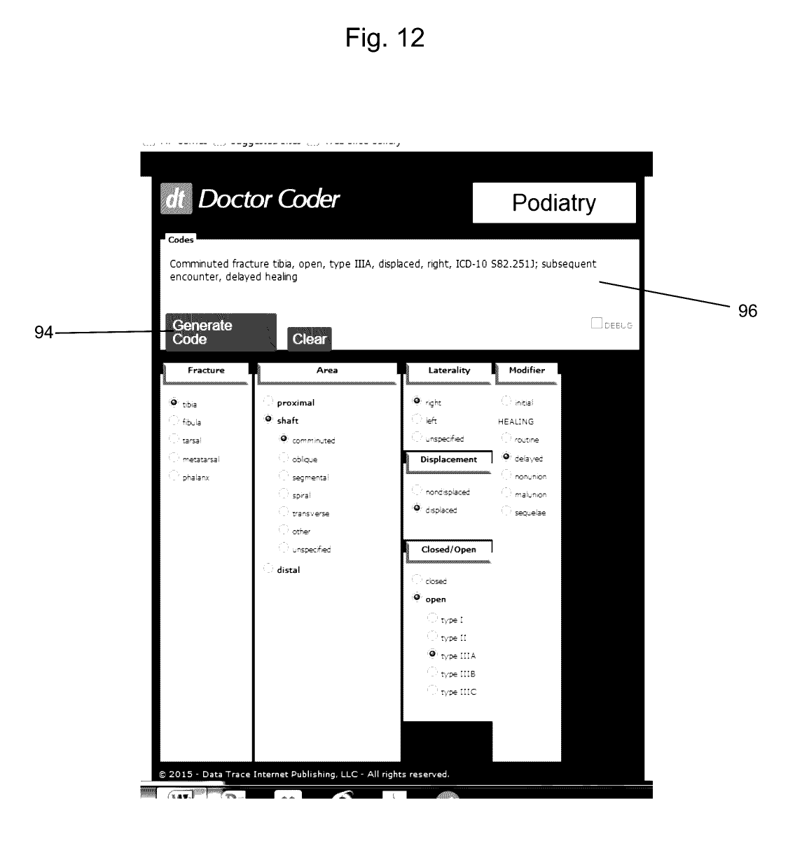

Once this final selection is made, the user clicks the generate code block 94 and the appropriate ICD-10 96 code appears to the top of the screen as shown in FIG. 12. In this present instance as shown in FIG. 12, the ICD-10 code is S82.251J, which is incorporated into the final bill with the terms: comminuted, fracture, tibia, open, Type 111A, displaced, right, subsequent encounter, delayed healing. These are the terms which have previously been selected in the prior menu.

This billing is generated back over the internet 24 to the user's computer 22 and if desired, to the user's billing location 23 at the office. The user 20 or user's billing office 23 then can use the diagnostic code coupled with the procedure code to submit the bill electronically or print the bill for a manual distribution to the designated payor. It should be noted that the bill is encrypted when it is transmitted from the host computer 26 to the user computer 22 or billing location computer 23 to preserve patient confidentiality but can be encrypted at any stage in the process. As an additional embodiment, software is designed to determine the appropriateness of the diagnostic code with the procedure code and to detail optimal questions within the history and suggest physical examination processes or prompt diagnostic testing or imaging.

After the series of menus on the prompt screens have been answered by the physician by clicking on the adjacent term circle, the physician or service provider has in effect created a diagnosis or list of diagnoses suitable for a billing report when he or she hits the block 96 marked “generate code”. While the clinical report is created manually by marking the terms of the respective prompt menu screen with a stylus or mouse, entry can optionally be made by touch screen, voice or speech recognition or a combination thereof.

The front-end computer 22 is linked to the back-end computer 26 through the Internet 24. This linkage may be either a wired or wireless linkage. Further, any other computer may be connected to or accessed from either the front-end computer 22 or the back-end computer 28 through the Internet.

At each information step, a mapping of professional billing codes is generated and sent to the designated recipient upon hitting the generate code block 94. The mapping associates each professional billing code (e.g., ICD-10-CM) with one or more of the specific diagnosis/procedure entries on each prompt screen menu designated term.

Preferably, the billing codes are matched with the selected terms of the menu nomenclature so that the billing directly corresponds with the ICD-10-CM terminology. Failure to provide the proper codes in the initial billing usually results in an initial denial of payment and a significant delay in the billing and the collection process. Using the latest revisions of the ICD codes such as ICD-10 can be difficult because the number of codes (including both diagnosis and procedure codes) increase from roughly 18,000 to 153,000 codes between ICD-9 and ICD-10. The prompt screen information matches with the appropriate ICD code provides for concise billing. In addition using this invention creates a detailed diagnosis with a description that facilitates care. It should be noted that any of the steps including the transmission of the final billing and recording of the billing in record archives can be encrypted.

Each computer program within the scope of the claims below may be implemented in any programming language, such as assembly language, machine language, a high-level procedural programming language, or an object-oriented programming language. The programming language may, for example, be a compiled or interpreted programming language.

The medical diagnosis menu screens may be implemented in a computer program product tangibly embodied in a machine-readable storage device such as servers 28 for execution by a computer processor 26. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk (not shown). These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

It is to be understood that although the invention has been described above in terms of particular embodiments which are provided as illustrative only, and do not limit or define the scope of the invention. Various other embodiments, including but not limited to the following, are also within the scope of the claims. For example, elements and components of the billing system described herein may be further divided into additional components or joined together to form fewer components for performing the same functions.

The techniques described above may be implemented, e.g., in hardware, software, firmware, or any combination thereof. The techniques described above may be implemented in one or more computer programs executing on a programmable computer including a processor, a storage medium readable by the processor (including, e.g., volatile and non-volatile memory and/or storage elements), at least one input device, and at least one output device. Program code may be applied to input entered using the input device to perform the functions described and to generate output. The output may be provided to one or more output devices.

As shown in FIG. 1, the billing and records system of the present invention is a front-end-back-end system, with an open standards-based software architecture as is commonly known in the art.

The use of a wireless, stylus based computer allows a care provider to enter all necessary data from the point of care with minimal equipment interference. All data generated can be encrypted as desired as is well known in the art before transmission over the internet or placed in storage in the cloud or other storage facility.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What is claimed is:

1. A billing method for diagnostic coding, documentation and billing for specialized medical practice, said method comprising: capturing a treatment event by accessing a host computer with a billing program having a plurality of prompt menu screens with data terms directed to a specialized medical practice with a remote device comprising the steps of:
(a) connecting a remote device to said host computer via the internet;
(b) entering specific treatment event data terms selected from data terms shown on said prompt menu screens which correspond to a patient diagnosis to said host computer;
(c) matching said selected treatment event data terms selected from said prompt menu screens to a specific billing code maintained in a database connected to said host computer;
(d) generating information for computerized charge entry or creating an invoice for all of the collected selected data terms entered with predetermined standard code identifiers for a specific patient from said host computer; and
(e) transmitting a completed invoice to said remote device.

2. The coding, documentation and billing method of claim 1 wherein said specific billing code is an ICD code.

3. The coding, documentation and billing method of claim 1 wherein said specific billing code is an ICD-10 code.

4. The coding, documentation and billing method of claim 1 wherein said specialized medical practice is podiatry is taken from a group consisting of podiatry, orthopaedic, neurology, cardiology and oncology.

5. The coding, documentation and billing method of claim 1 wherein said remote device is taken from a group of devices consisting of a smart watch, smart phone, tablet, notebook, laptop and stand-alone computer.

6. The coding, documentation and billing method of claim 1 wherein said remote device is a computer.

7. The coding, documentation and billing method of claim 1 wherein said billing code is taken from a group of codes consisting of CPT-4 (Current Procedural Terminology, Version 4) codes, HCPCS (Healthcare Common Procedure Coding System) codes, ICD-9-CM (International Classification of Diseases, Ninth Revision, Clinical Modification) codes and ICD-10-CM (International Classification of Diseases, Tenth Revision, Clinical Modification) codes.

8. A computer implemented method for processing ICD coding, documentation and medical billing records relating to specialized medical care provided to patients, the ICD billing records capturing charges to be submitted to a payer, the method comprising:
(a) a host computer being provided with a database of one or more ICD coding, documentation and billing codes and a set of sequential screen menus containing and displaying treatment procedure terms expressed as specific terms for a medical specialty which terms are connected to said one or more codes;
(b) a remote computer used by a medical professional to access said host computer and to select one or more terms listed on menu screens generated by a host computer;
(c) entering a plurality of treatment procedure terms selected by a medical practioner on said remote computer from the same terms displayed on said set of sequential screen menus to facilitate entry of billing codes relating to the medical care provided to the patient;
(d) automatically reconciling the entries of said selected terms on said sequential screen menus by said host computer with said billing codes to facilitate identification of said one or more professional billing codes; and
(e) said host computer populating said remote computer with a list of treatment procedure terms selected from said set of sequential screen menus with one or more ICD billing codes to provide a coding, documentation and billing record to said remote computer.

9. The coding, documentation and billing method of claim 8 wherein said remote computer is taken from a group consisting of cell phones, smart phones, smart watches, tablets, notebooks, laptops and computers.

10. A computer enabled product for processing billing records relating to a medical specialty area treatment provided to patients at a medical facility; said computer enabled product residing on a host computer database with computer readable medium having a plurality of medical diagnostic menu screens stored thereon, each of said menu screens containing medical terms, billing code information stored on a database connected to said host computer and comprising a computer readable medium, said billing code information including a list of medical ICD codes, each said medical ICD coding, documentation and billing code being assignable to one or more medical terms of said menu screens causing said host computer processor to: capture medical terms entered by a medical professional to generate a professional billing record relating to medical procedures provided by the professional medical provider to a patient, said coding, documentation and billing record comprising one or more ICD billing codes corresponding to one or more medical terms selected by said medical service provider from said menu screens along with the same medical terms on said menu screens previously entered by said medical professional to populate a billing record,

11. The product for processing billing records of claim 10 wherein the diagnostic and billing codes comprise ICD-9-CM (International Classification of Diseases, Ninth Revision, Clinical Modification) codes and ICD-10-CM (International Classification of Diseases, Tenth Revision, Clinical Modification) codes.

12. The product for processing billing records of claim 10 wherein said menu screens are a series of pop-up menus.

13. A method as claimed in claim 8 wherein said treatment procedure terms represent terms defining a patient procedure performed on a patient during a patient encounter.

14. A method for providing code-driven medical reporting for billing, comprising: providing a user interface adapted for operation on a first computer; using the user interface to collect at least one procedure term representing a procedure performed on a patient during a patient encounter; for each of the procedure term, using the user interface to collect a plurality of diagnosis terms taken from a plurality of menu screens, each of the plurality of diagnosis terms representing a diagnosis of the patient during the patient encounter to thereby establish a user defined link between each of the plurality of procedure terms and a plurality of billing codes documenting the patient encounter by storing each of said marked procedure terms from said menu screens and matching at least one ICD-10 code to each of the selected diagnosis terms to provide a billing record of each diagnosis of a patient, and transmitting said billing record to a second remote computer.

15. A method as claimed in claim 14 wherein billing code information stored on the computer readable medium, includes a comprehensive list of medical billing codes, each said medical billing code being assignable to one or more individual medical terms.

16. A method performed by at least one computer processor executing computer program instructions stored on at least one non-transitory computer-readable medium, the method comprising:
(a) generating an initial set of medical procedure terms based on entry of selected terms directed to a medical specialty on a host computer to a remote computer;
(b) selecting those medical procedure terms which related to a specific patient on said remote computer and sending same to a host computer;
(c) comparing a set of billing codes encoded according to a ICD-10 billing code standard, with said procedure terms with said host computer;
(d) generating selected procedure terms correlated to billing codes on said host computer;
(e) generating a final bill, encoded according to the billing code standard, based on the procedure terms selected by the user on said host computer; and
(f) transmitting an encrypted bill having said selected procedure terms together with billing codes based on said procedure terms to a remote computer.

17. The method according to claim 16 wherein in step (f) the bill is transmitted to a second remote computer.

18. The method according to claim 16 wherein in step (f) the bill is transmitted to a payor.

19. The method according to claim 16 wherein said medical specialty is any medical or surgical related medical provider that requires ISD-9 or ICD-10 codes for diagnosis, documentation or billing.
